(19) United States
(12) Patent Application Publication
(10) Pub. No.: US 2004/0256935 A1
(43) Pub. Date: Dec. 23, 2004

(54) Magnetic bearing with permanent magnet poles

(76) Inventors: Andrew Kenny, College Station, TX (US); Alan B. Palazzolo, College Station, TX (US)

Correspondence Address: Andrew Kenny, 1510 A Pineridge Street, College Station, TX, 77840, US

(21) Appl. No.: 10/465,149

(22) Filed: Jun. 19, 2003

(51) Int. Cl. H02K 7/09

(52) U.S. Cl. 310/90.5

(57) ABSTRACT

A single plane magnetic bearing stator comprises of a ring. Attached to the side of the ring closest to the bearing rotor are permanent magnets. These magnets are radial poles. These permanent magnet poles are all magnetically oriented to only push magnetic flux into the ferromagnetic. This stator also has non permanent magnet ferromagnetic radial poles which are split into prongs. Between the prongs is a permanent magnet. The permanent magnet flux exits the rotor through these ferromagnetic prongs called split poles. The amount of magnetic flux that enters the split poles is modulated by electric coils on the ferromagnetic poles which wrap around the whole split pole unit. This way a controllable force between the rotor and each split ferromagnetic pole can be achieved.

### CROSS-REFERENCE TO RELATED APPLICATIONS

Not applicable

### BACKGROUND

1. Field of Invention

This invention relates to permanent magnet poles on the stator of a single plane bearing which are use to provide bias flux through non permanent magnet poles on the stator.

2. Description of Prior Art

Magnetic bearings levitate a shaft so that the shaft can turn freely with no contact support. Electric coils can be used to control the magnetic flux and maintain it in position. The relation between the current in the electric coils and the force on the rotor can be made linear by providing a bias magnetic flux.

U.S. Pat. No. 5,111,102 to Meeks (1992) describes a permanent magnet configuration that provides bias flux via permanent magnets. This was a two plane design. In other words the rotor could not be supported at just one axial location. The disadvantages of this two plane design are: the rotor must still be supported at two places and two stators are needed in separated planes along the axis of the rotor. Thus the two plane design is inherently more complex than a single plane design where the rotor can be supported by a single plane of poles in one axial position.

Because of the disadvantages of the two plane type of magnetic bearing inventors have created several types of single plane magnetic bearings and some of these single plane bearings have been successfully biased with permanent magnets. The early inventions in this area either did not use the permanent magnet to provide bias flux but only bias force; or they forced the control flux to go through the permanent magnets. Both of these are significant drawbacks. Inventions of this type are disclosed in Japanese Patent 11101234 to Yamamoto (1999) and U.S. Pat. No. 5,095,237 to Bardas, et. al. (1991). The goal of a single plane bearing which is biased by permanent magnets was disclosed by two inventors. In European Patent 1072807A to Yamauchi and Kuwahara (2001) and in U.S. Pat. No. 5,355,042 to Lewis et. al. (1994). The disadvantage of both these inventions is that the permanent magnets are placed in the circumferential section of the stator. The stator is not a single circular unit. It is a much weakened and more complicated multipart ring.

European patent 1247026 to Silber and Amrhein (Sep. 10, 2002) discloses a single plane bearing which uses permanent magnet poles to provide the bias flux. The permanent magnets are aligned in the radial direction and they are oriented to push magnetic flux into the rotor. This flux exits the rotor through non permanent magnet poles which are ferromagnetic. The amount of magnetic flux that enters the poles is modulated by electric coils on the ferromagnetic poles in order to produce a controllable force between the rotor and each ferromagnetic pole. This arrangement is shown in FIG. 1 and in fact overlaps some of the claims of our invention for which a provisional patent application was filed on Jul. 19, 2001. Silber et. al. also have a U.S. patent application publication US 2003/0001447 A1, Jan. 2, 2003 in which is nearly identical to their European patent.

There are disadvantages to the invention of Silber et. al. Their invention does not takes advantage of wrapping a coil around permanent magnet poles and ferromagnetic poles simultaneously. The permanent magnet poles in their patent are difficult to protect. They suggest covering the permanent magnets with sheet metal, but this is burdensome. Also the bias flux has to travel a long distance through the rotor in their invention because there is a wall of coil windings between their permanent magnet poles and their ferromagnetic poles.

Our invention does not have the disadvantages of the invention of Silber et. al. Our invention is illustrated in papers by A. Kenny and A. B. Palazzolo et. al. which describe how to design the single plane bearing with permanent magnet poles so that they may work efficiently. These papers are “Single plane radial, magnetic bearings biased with poles containing permanent magnets”, ASME Journal of Machine Design, Vol 125, March 2003, pp 178 to 185. and “Novel actuator for magnetic suspensions of flywheel batteries, by 36^{th} Intersociety Energy Conversion Engineering Conference, Jul. 29-Aug. 2, 2001, Savannah, Ga., IECEC2001-AT-84.

All prior inventions until our invention suffer from a number of disadvantages. These include:

(a) They support the rotor in two or more axial locations using two or more planes of poles were where the magnetic flux enters the rotor.

(b) They support the rotor in a single axial location but they do not use permanent magnets for bias flux.

(c) They support the rotor in a single axial location and they use permanent magnets for bias flux, but the stator is a complex set separate permanent magnets and stator parts.

(d) They support the rotor in a single location with single plane stator which is a strong unit without any circumferential breaks, but the permanent magnet poles are not well protected by adjacent ferromagnetic control poles or the control coil wrapping.

### SUMMARY—OF OUR INVENTION

Magnetic bearings consist of several major subsystems required to levitate and stabilize a rotor. These include position and speed sensors, microcontrollers, power amplifier, and more. Our invention relates to the stator. This stator with its coils, permanent magnet poles, and split poles is meant to function in concert with the other subsystems.

In accordance with the present invention a single plane magnetic bearing stator comprises of a ring which does not have to be round. Attached to the side of the ring closest to the rotor are permanent magnets for poles all aligned in the radial direction. These permanent magnet poles are all magnetically oriented to only push magnetic flux into the ferromagnetic. This stator also has non permanent magnet ferromagnetic radial poles which are split so that each one has a permanent magnet inside the split. The permanent magnet flux exits the rotor through these ferromagnetic poles. The amount of magnetic flux that enters the split poles is modulated by electric coils on the ferromagnetic poles which wrap around the whole split pole unit. This way a controllable force between the rotor and each split ferromagnetic pole can be achieved.

Our present invention is illustrated by FIGS. 2-4. FIG. 2 and FIG. 3 are identical except for labeling which would be excessive all shown on one figure. FIG. 4 shows a front view of our invention, while FIG. 2 and FIG. 3 show a cross section that cuts through the electric coils.

The ferromagnetic poles are sometimes referred to as split poles because they are split into two prongs with a permanent magnet in between them. They are also sometimes referred to as control poles because the magnetic flux in them is modulated by the current in the coil that wraps around them to control the force on the rotor. The permanent magnet poles are sometimes referred to as bias poles because their purpose is to provide the bias magnetic flux for the bearing.

### OBJECTS AND ADVANTAGES

This innovative present invention avoids some of the key drawbacks of the prior art while retaining some of their key advantages. For instance with the proposed invention:

(a) The stator remains a single circumferential unit without any circumferential segments to weaken or complicate it.

(b) The permanent magnet poles provide a bias flux so that the rotor can be levitated with very little electric power.

(c) The permanent magnet poles provide the bias flux so that the current flowing in the coils around the ferromagnetic poles does not need to have a bias current component.

(d) All the magnetic flux flows in one plane which when made from a laminate stack will result in very low amounts of eddy currents being produced and so very low amounts of eddy current will be generated.

(e) The design effort is not complicated because there is only one plane and a detailed examination of leakage between axial planes and stacking factor reluctance effects do not have to be analyzed.

(f) A short axial length is easier to obtain than with a two plane bearing and the radial force only needs to be applied at one axial location.

(g) The stator is a strong simple single plane unit with no circumferential segments.

(h) The permanent magnet poles are protected by the split ferromagnetic control poles and by the electric coil which wraps around both the permanent magnet pole which is between the split poles of the control pole.

(i) The flux from the permanent magnet has a short travel distance in the rotor because the permanent magnet poles are adjacent to the split poles without being separated by a coil. This means the reluctance path of for the permanent magnet flux in low and which helps reduce the cost of the permanent magnets.

### DRAWING FEATURES

FIG. 1 Prior Art. Single plane permanent magnet biased design disclosed in European patent 1247026.

FIG. 2 and FIG. 3 show our invention by a cross section view. The only difference between the two is the labels.

FIG. 4 shows how the coils wrap around and protect the fragile brittle permanent magnet in our invention.

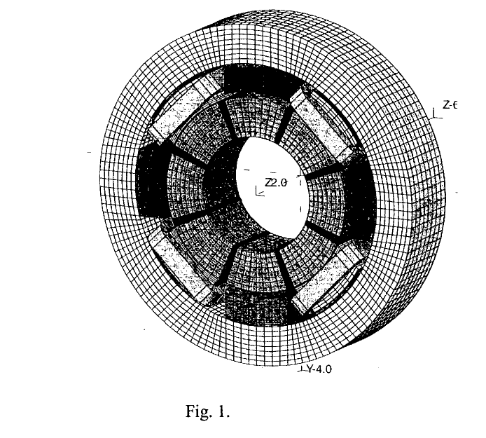

61, 62, 63, 64, 65, 66, 67, and 68 split ferromagnetic control poles

23, 25, 27, 29 electric control coils

50 rotor

60 stator

71, 73, 75, 77 bias pole gaps

81, 81, 83, 84, 85, 86, 87, 88 split pole gaps

91, 92, 93, 94, 95, 96, 97, 98 bias flux paths

102, 104 control flux paths

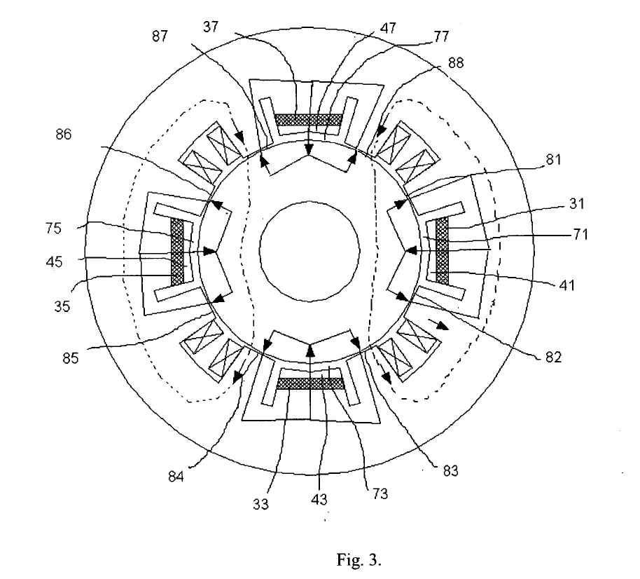

### DESCRIPTION FIG. 3—PREFERRED EMBODIMENT

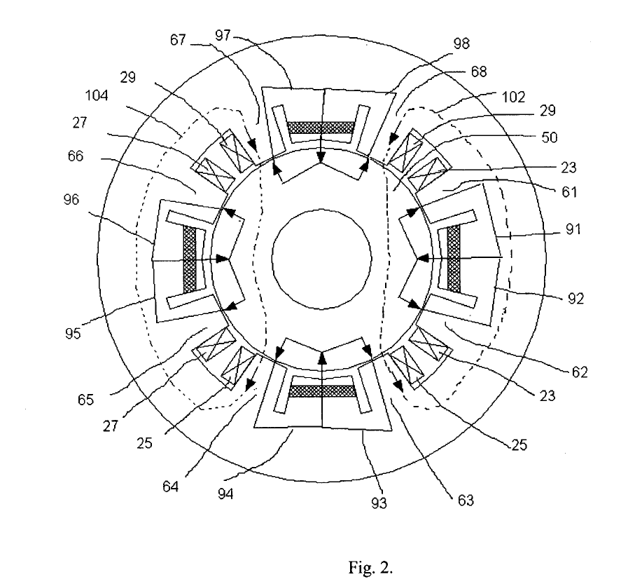

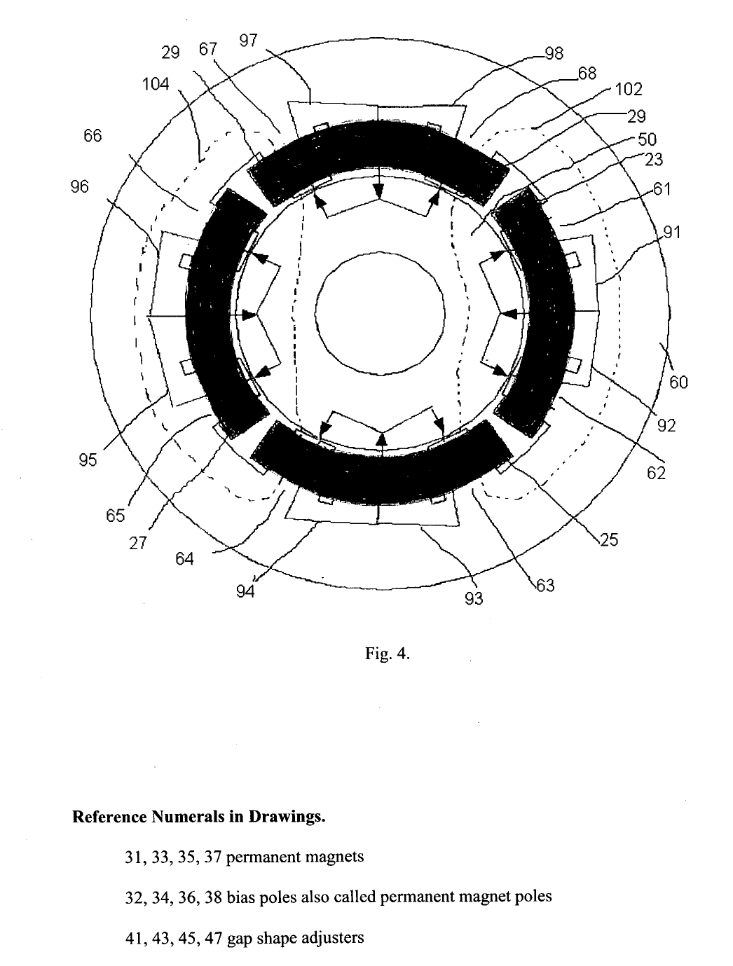

A preferred embodiment is shown in FIGS. 2-4. The permanent magnet poles are between the split ferromagnetic control poles. Certain of the control poles work as a unit with the bias poles and magnets between them. Numbers 61 and 62 indicate the two prongs of one split pole. Between them is permanent magnet 31 and gap shape adjuster 41. Numbers 31 and 41 make a permanent magnet pole. Wrapping entirely around this group of parts (61,61,31, and 41) is a control coil indicated by number 23. The current in this coil modulates the flux that travels through the ferromagnetic split poles. Thus numbers 61, 62, 31, 41, and 23 make a sub unit. There are three similar sub units shown in FIG. 3 to make it possible to pull the rotor left and right and up and down. These sub units are (63, 64, 33, 43, 25) and (64, 65, 35, 45, 27) and (66, 67, 37, 47, 29).

The permanent magnets are all oriented in the same direction. That is they all have their north side closest to the rotor and their south side farthest from the rotor. Alternatively they all could have their south side closest to the rotor.

Additional Embodiments.

Although FIGS. 2 to 4 show four sub units of split and bias poles however any number could be used depending on the number of directions that needed to be applied to a rotor for a particular application. At least three units will be required to generally control rotor movement in the plane of the stator.

The split poles do not have to all be the same width or length even though they are shown so in FIG. 3. Similarly the permanent magnets and the permanent magnet poles do not all have to be the same width or length. For example the bias force could be made to pull up and help counter gravity by making split poles 67 and 68 closer to the rotor than split poles 63 and 64. This would make the flux density in gaps 87 and 88 higher than the flux density in gaps 83 and 84.

The gap shape adjusters are optional. The permanent magnet end nearest to the rotor can be cut to achieve the desired gap shape instead, although flat permanent magnets are usually less expensive. The gap shape adjusters do not have to follow the contour of the rotor, nor may it always be advantageous to do so especially for high rpm applications where the gap should be slightly larger near the edges of the pole to reduce rotor eddy currents.

Operation

The flux from the permanent magnets always only enters the rotor. This flux must also exit the rotor and it exits through the air gaps between the rotor and the split poles. To cause the rotor to be pulled toward a certain split pole the current in the coil around that pole is adjusted to increase the amount of flux caused by the coil. And it is adjusted so that it flows in the same direction as the permanent magnet flux exiting the rotor and entering the control pole. In this manner the total amount of flux in the gap between the rotor and this split pole is increased. This causes the rotor to be pulled harder toward this split pole. The relation between the current in the coil around the split pole and permanent magnet unit will be linear if when the current is increased in the coil the current in the coils on the other side of the rotor is simultaneously decreased.

Conclusions, Ramifications and Scope

Our invention has several advantages. The whole stator occupies just one plane making it much simpler than two plane designs. The permanent magnets supply bias flux in a way that allows for a linear relation between current in the coils and the force produced on the rotor. The flux from both the coils and the permanent magnet flows in the same plane which is the best possible situation for a laminated rotor and stator. The position of the permanent magnet makes the bias flux path in the rotor very short and the permanent magnet gets protected both by the coil and by the split control pole.

I claim:

1. A single plane magnetic bearing stator comprising of an outer ring and, inwardly radially directed from the ring, ferromagnetic poles split into a pair of prongs and between said prongs a permanent magnet pole with radial north-south orientation and wrapped around said prongs and said permanent magnet pole an electric coil.

2. The stator of claim 1 where in there are several sub units of said prongs, said permanent magnet, and said coil all with the same north south radial orientation of the permanent magnet and said sub units are spaced around the ring inner edge of the ring so that magnetic force can be controlled in several directions by varying the current in the coils of the sub units.

3. A single plane magnetic bearing stator comprising of an outer ring and, extending in from the ring toward a central rotor to be magnetically levitated, permanent magnet poles all with the same radial north-south orientation which are between pairs of ferromagnetic poles adjacent to but not touching said permanent magnet poles, and around each pair of ferromagnetic poles with the permanent magnet pole between them is an electric coil by which the flux in the gap between the ferromagnetic poles and the rotor can be modulated in order to control the magnetic force on the rotor.
